(19) United States
(12) Patent Application Publication
(10) Pub. No.: US 2002/0153090 A1
(43) Pub. Date: Oct. 24, 2002

(54) Poster saver

(76) Inventor: Clayton Schwartz, Seattle, WA (US)

Correspondence Address: CLAYTON SCHWARTZ, 4739 UNIVERSITY AVE #1320, SEATTLE, WA, 98105, US

(21) Appl. No.: 10/112,298

(22) Filed: Mar. 30, 2002

Related U.S. Application Data
(60) Provisional application No. 60/280,922, filed on Apr. 3, 2001.

(51) Int. Cl. B31F 1/00

(52) U.S. Cl. 156/252; 156/221; 156/227

(57) ABSTRACT

The invention allows one to hang posters with tacks without concern that the tacks will damage them. It is cheap, novel, and easy to use and consists, in its most basic form, of a specialized adhesive tab which reinforces the poster against damage. It is cheap to manufacture and research and development costs are minimal.

I hereby claim the benefit under 35 U.S.C. 119(e) of U.S. Provisional patent Application No. 60/280,922 filed on Apr. 3, 2001.

### CROSS-REFERENCE TO RELATED APPLICATIONS:

Not Applicable.

### STATEMENT REGARDING FEDERALLY SPONSORED RESEARCH OR DEVELOPMENT:

Not Applicable.

### REFERENCE TO SEQUENCE LISTING, A TABLE, OR A COMPUTER PROGRAM LISTING APPENDIX

Not Applicable.

### BACKGROUND OF INVENTION

The purpose of the invention is to prevent posters, notices, signs, and the like from being damaged by tacks or nails used to hang them.

### BRIEF SUMMARY OF THE INVENTION

Using tacks is a popular and convenient method of hanging posters. The problem is that tacks tear into and mar posters. My invention solves this problem. It is a thin, tear-resistant tab with adhesive on one side which adheres to the poster at the site where a tack will be used. The tack is pushed through the tab, which takes the strain that would otherwise damage the poster.

### BRIEF DESCRIPTION OF THE SEVERAL VIEWS OF THE DRAWING

Not Applicable.

### DETAILED DESCRIPTION OF THE INVENTION

The invention is made of a thin, pliable, tear resistant material suited to the purpose, likely a plastic. It is pliable so it can be permanently affixed to the poster and rolled with it for storage. It may be of any color, including transparent. There is adhesive on one side. Concerning its shape, the square or isosceles right-triangle seem most appropriate, though others might be considered. Its size is not set, but will likely fall between four and fifty square centimeters. It may have a small hole pre-punched in it for the tack to go through, if such would increase its durability or convenience. The tab is adhered to the poster and a tack or nail is pushed through it. A variation on the basic idea has the product fold in half and adhere to both sides of the poster, leaving a tab extending past the edge of the poster for the tack to go through. A second variation involves a loop of wire attached to or otherwise incorporated into the tab. The loop extends just barely past the corner of the poster, allowing the poster to be hung without putting a hole in it.

What I claim as my invention is:

1) Poster Savers are thin, pliable, adhesive tabs of tear-resistant material to be used for reinforcing the corners of posters and signs against stresses caused by hanging them with tacks or nails. Such may
a) Have small holes pre-punched in them.
b) Be of various colors.
c) Be of various shapes.

2) They may be designed to fold over and adhere to both sides of the poster, leaving a tab extending past the comer of the poster through which a tack or nail can be pushed.

3) They may have incorporated into them wire loops designed take the load of stress, and in one design variation to extend past the corners of the poster.
In compliance with the statute, the invention has been described in language more or less specific as to structural features. It is to be understood, however, that the invention is not limited to the specific features described, since the means and construction described compromise preferred forms of putting the invention into effect. The invention is, therefore, claimed in any of its forms or modifications within the legitimate and valid scope of the appended claims, appropriately interpreted in accordance with the doctrine of equivalents.
